(19) United States
(12) Patent Application Publication
(10) Pub. No.: US 2012/0312015 A1
(43) Pub. Date: Dec. 13, 2012

(54) THERMOELECTRIC HYDROGEN HYBRID CAR

(76) Inventor: Dana Ng, West Covina, CA (US)

(21) Appl. No.: 13/158,415

(22) Filed: Jun. 11, 2011

(51) Int. Cl. F02G 5/02

(52) U.S. Cl. 60/614

(57) ABSTRACT

A thermoelectric hydrogen hybrid vehicle for use with fossil fuel, the thermoelectric hydrogen hybrid vehicle has a closed loop steam engine. The steam engine's boiler is a high temperature electrolysis unit. Inside the internal combustion engines exhaust heat is directly funneled into heating the high temperature electrolysis boiler. The steam engines electrical current generated through an alternator is then stored in a battery bank and then used for sustained current for electrolysis in the high temperature electrolysis boiler. Furthermore a braking mechanism is hooked up to the alternator for electrical generation when braking to be stored in a battery bank which is then used for electrolysis.

### CROSS REFERENCES TO RELATED APPLICATIONS

Ser. No. 12/590,653 & U.S. Pat. No. 3,537,910

### REFERENCE TO FEDERALLY SPONSORED RESEARCH OR DEVELOPMENT

NA

### REFERENCE TO JOINT RESEARCH AGREEMENTS

NA

### REFERENCE TO SEQUENCE LISTING

NA

### BACKGROUND OF THE INVENTION

1. Field of the Invention

The present invention relates generally to mobile hydrogen production systems, and, in particular, relates to hydrogen internal combustion systems for use with automobiles, and, in greater particularity, relates to an efficient means to generating hydrogen in mobile internal combustion engine automobiles.

2. Description of the Prior Art

The use of electrolysis in hydrogen production is well known. One such application is to apply electrolysis onboard automobiles to generate hydrogen for internal combustion engines. Although the electrolysis method does generate small amounts of hydrogen, this process is not efficient as it uses more energy to turn the alternator than it generates in hydrogen.

Even the most efficient internal combustion engines are subject to losing, on average, 60% of their fossil fuel energy through heat from the exhaust and tail pipes. In fact, instead of reutilizing this heat for further energy production automobiles utilize radiators to disperse the excess heat generated from the internal combustion process.

To recycle the 60% of fossil fuel energy lost through heat, some manufacturers have developed thermoelectric generators and steam engine add-ons to harness this lost energy. This effect may be achieved by utilizing the Peltier effect by applying a high heat difference to generate electricity at a 10% efficiency rate. This effect may also be achieved by utilizing a steam engine by applying heat to a boiler and utilizing pressure to operate a steam engine to turn an alternator to generate electricity. Still the conversion of heat to electricity to hydrogen remains a problem due to loss of energy through conversion. An efficient means to convert h2o to hydrogen onboard a vehicle remains a problem.

### SUMMARY OF THE INVENTION

The present invention is directed at an efficient mobile onboard means of splitting H2O into hydrogen and oxygen, through the means of utilizing the excess heat produced by internal combustion engines and the kinetic energy lost through braking.

The internal combustion engine loses a large portion of kinetic energy through braking, nearly ⅓ on average. It's second biggest inefficiency is the fossil fuel energy lost through heat. According to an article published by the Department of Energy, on average 60% of fossil fuel energy is lost this way, while only 40% is used towards kinetic energy for propelling internal engine cylinders. Thus, we have losses in both kinetic energy and heat energy in an internal combustion engine system.

In order to make use of the excess heat, the present invention comprises of a high temperature electrolysis boiler which propels a steam engine through steam to make use of kinetic energy, while the heat energy inside the boiler is made use of by assisting conversion of H2O into hydrogen through thermolysis. Meanwhile, the kinetic energy through steam pressure is generating electricity by the steam engine and the alternator. The electricity generated by the alternator is then used for electrolysis within the high temperature electrolysis boiler.

In addition, an electric alternator braking system is also used to generate additional electricity delivered directly to the high temperature electrolysis boiler.

The loop cycle is as described, if 100 units of fossil fuel energy is used in the internal combustion process, 40 units of kinetic energy will be used towards propulsion of the wheels, 60 units of heat energy will be used for high temperature electrolysis with a 46% heat to hydrogen efficiency, thus equaling 27.6 units of hydrogen energy. Then, the 27.6 units of hydrogen energy are sent back into the internal combustion engine for a 40% efficiency where 11.04 units of kinetic energy is used to propel the wheels and again 16.5 units of heat energy is sent back to the high temperature electrolysis boiler for a 46% efficiency conversion to 7.59 units of hydrogen energy which is then sent back to the internal combustion engine.

In addition, the alternator braking system generates more electricity through kinetic energy, previously lost through braking, to provide more electricity for aiding further electrolysis. So if 100 units of fossil fuel energy are spent on a 40% efficiency internal combustion engine, only 40 units of kinetic energy is sent to the wheels, where then ⅓ of those 40 units, or 13.33 units, of kinetic energy is lost through braking. Those 13.33 units of kinetic energy are then harnessed through an alternator which is then sent to aid in the high temperature electrolysis boiler for additional hydrogen production.

The estimated efficiency of the present invention based on an average 40% efficiency internal combustion vehicle & on an average of ⅓ efficiency lost through braking is as calculated.

FF=Fossil Fuel, ICEE=Internal Combustion Engine Efficiency, KE=Kinetic Energy, EH=Exhaust Heat, HE=Heat Energy, ELB=Energy Lost through Braking, BE=Brake Energy, HTEE=High Temperature Electrolysis Efficiency, HOE=Hydrogen Oxygen Energy, EE=Electrolysis Efficiency.

100FF*0.401CEE=40KE

100FF*0.60EH=60HE

40KE*0.33ELB=13.33BE

60HE*0.46HTEE=27.6HOE

27.6HOE*0.401CEE=11.04KE

11.04KE*0.33ELB=3.64BE

27.6HOE*0.60EH=16.56HE

16.56.46HTEE=7.61HOE

13.33BE+3.64BE=16.97BE

16.97BE*0.70EE=11.87HOE

27.6HOE+7.61HOE=35.21HOE

11.87HOE+35.21HOE=47.08HOE

47.08% Estimated Added MPG Efficiency in City.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 is an overall view of the system thereon of a preferred embodiment of the present invention;

### DETAILED DESCRIPTION OF THE PREFERRED EMBODIMENTS

The present invention is a hydrogen hybrid car system created to make use of all lost energy, in particular kinetic and heat energy, through the use of a high temperature electrolysis boiler, a steam engine and also through the use of a braking system linked to an alternator where wasted kinetic energy can be harnessed.

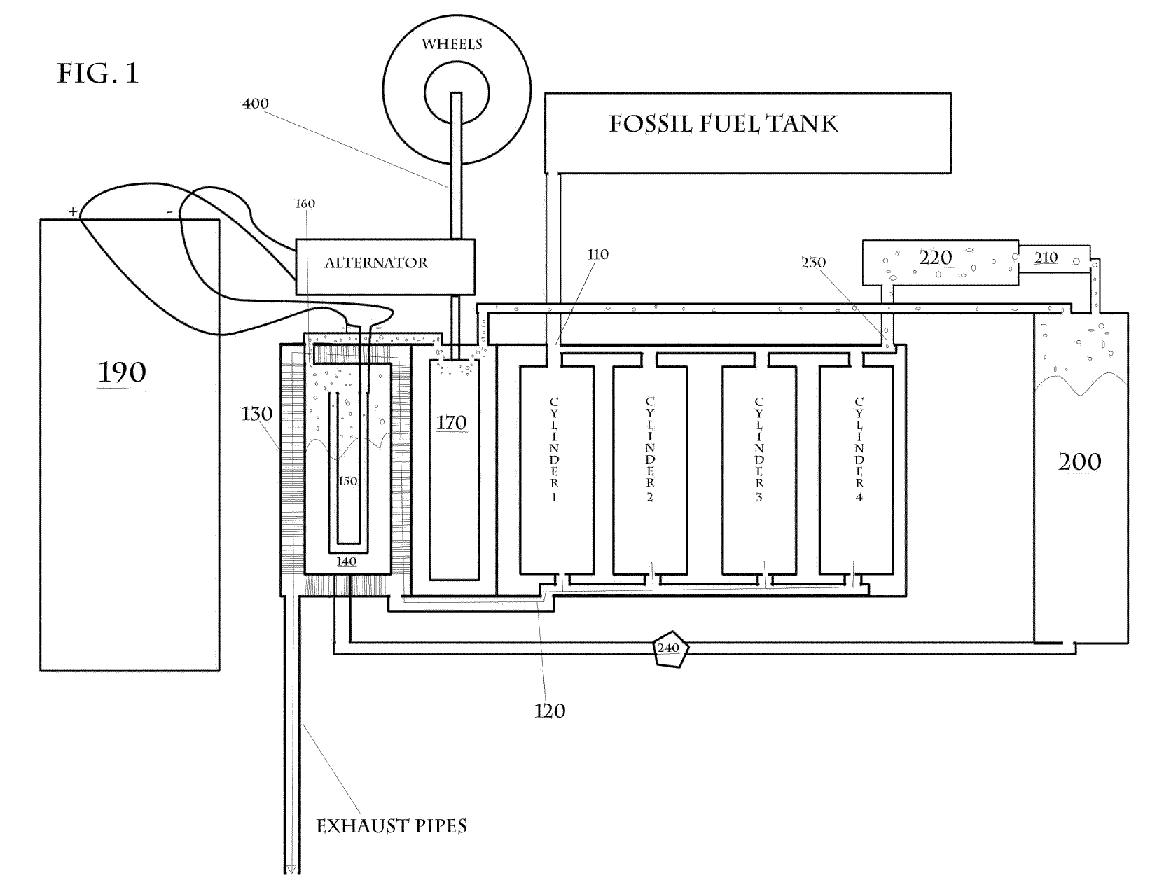

Turning to the drawings, wherein like components are designated by like reference numerals throughout the various figures, attention is initially directed to FIG. 1 which illustrates an overall view of a onboard hydrogen generating system constructed according to the present invention.

As best shown in FIG. 1, the onboard hydrogen generating system maintains a traditional fossil fuel injection system as shown 110 with a 4 cylinder engine. Attached to the exhaust pipes of the 4 cylinders 120 is another exhaust pipe to channel heat directly to the high temperature electrolysis boiler 150, where heat is then funneled through an elaborate maze of heat absorbers 130 encasing the high temperature electrolysis boiler 150 which is filled with H2O 140. This high temperature electrolysis boiler 150 provides means for boiling H2O 140 to steam form to generate pressure which is then sent into the 5^{th} cylinder steam engine 170, the steam powered 5^{th} cylinder steam engine 170 is then used to turn the alternator.

The alternator then generates electricity to be transferred to a battery pack 190 to store electricity and provide a consistent flow of volts and amps to perform electrolysis in the high temperature electrolysis boiler 150, then together H2O steam, hydrogen, and oxygen in concentrated pressure is sent into power the 5^{th} cylinder steam engine 170. FIG. 1 shows a bridge between the 5^{th} cylinder steam engine 170 and the cooling tank 200 where H2O steam reforms back into liquid form & where hydrogen & oxygen is filtered out by a high temperature hydrogen membrane filter 210. The hydrogen & oxygen is then fed directly into the vehicles air intake chamber 220, where it mixes with fossil fuel 230 to enter the internal combustion engines cylinders for combustion. After that, the remaining heat from combustion is recycled again through this process.

The present hydrogen generating system maintains an alternator braking system 400 which generates electricity every time the vehicle brakes. The electricity is then fed into the battery bank 190 for a controlled electric current to be sent into the high temperature electrolysis boiler 150. The present hydrogen generating system also contains a cooling tank 200 loop system to maintain maximum efficiency for the 5^{th} cylinder steam engine 170. In the cooling tank 200, the H2O in vapor form is cooled just enough to change back into liquid form, which is then pumped 240 back into the high temperature electrolysis boiler 150 and used for further heating & conversion.

What is claimed is:

1. A thermoelectric hydrogen hybrid vehicle, said vehicle comprising:
A high temperature electrolysis boiler connected directly to an internal combustion engines exhaust. A steam engine connected/powered directly by the said high temperature electrolysis boiler. Said steam engine and a braking system are connected to and turns an alternator. Said alternator's produced energy is stored in a battery. Battery's stored electricity is connected to said high temperature electrolysis boiler for means of splitting H2O.

2. The thermoelectric hydrogen hybrid car as recited in claim 1, wherein said means therein for splitting the H2O is through electricity and heat.

3. The thermoelectric hydrogen hybrid car as recited in claim 1, wherein contains a cooling tank for a closed loop steam engine system.

4. The thermoelectric hydrogen hybrid car as recited in claim 3, wherein the closed loop steam engine system contains a pump.

5. The thermoelectric hydrogen hybrid car as recited in claim 3, wherein the cooling tank contains a high temperature hydrogen membrane filter.
